(19) United States
(12) Patent Application Publication
(10) Pub. No.: US 2009/0065961 A1
(43) Pub. Date: Mar. 12, 2009

(54) Fibre Reinforced Composite and Method of Forming the Same

(76) Inventors: Chieh Yin Teo, Singapore (SG); Kazutoshi Fujihara, Singapore (SG); Poey Ling Loh, Singapore (SG); Weng Chiong Foong, Singapore (SG); Vijay Kumar Ganesh, Singapore (SG); Seeram Ramakrishna, Singapore (SG); Chong Lin Chew, Singapore (SG)

Correspondence Address: LACKENBACH SIEGEL, LLP, LACKENBACH SIEGEL BUILDING, 1 CHASE ROAD, SCARSDALE, NY, 10583, US

(21) Appl. No.: 11/738,781

(22) Filed: Apr. 23, 2007

Related U.S. Application Data
(62) Division of application No. 10/871,462, filed on Jun. 18, 2004, now abandoned.
(60) Provisional application No. 60/479,394, filed on Jun. 18, 2003.

(51) Int. Cl. A61C 7/00

(52) U.S. Cl. 264/16

(57) ABSTRACT

A method for forming an orthodontic device having a fibre reinforced composite is provided. The fibre reinforced composite has a fibre material within a matrix phase material. The fibre material comprises braided fibre material having a braid angle in the range from about 3° to about 87°, and more particularly in the range from about 10° to about 45°. The fibre reinforced composite is formed from a method which includes the steps of impregnating the fibre material with a monomer resin, shaping the fibre that is impregnated with the resin into a defined cross sectional shape suitable for use in the orthodontic device, and polymerising the monomer resin in the impregnated fibre to form the fibre-reinforced composite.

### PRIOR RELATED APPLICATIONS

This application claims priority to application Ser. No. 60/479,394, filed Jun. 18, 2003 and is a divisional application of and claims priority to application Ser. No. 10/871,462, filed Jun. 18, 2004 and incorporates the above-identified applications in their entireties by reference thereto.

### FIELD OF THE INVENTION

The present invention relates to a method of forming a fibre reinforced composite.

### BACKGROUND OF THE INVENTION

Fibre reinforced composites are popular as materials for use in medical treatment, in particular orthodontic treatment, owing to its mechanical strength, low density, pleasant aesthetics and chemical resistance.

Orthodontic brackets made of metallic materials, such as stainless steel, have proven to work well However, such brackets are opaque, and can therefore be detrimental to the beauty of the wearer. To overcome the problem, non-metallic materials that are transparent or translucent, such as plastic or ceramic, are desirably employed to make the brackets.

While plastic brackets may be aesthetically pleasing, they lack the mechanical strength of metallic brackets and are easily deformed under loading conditions. Ceramic brackets, despite having high resistance to deformation, are generally brittle and tend to fracture prematurely.

In view of the shortfalls of metallic, plastic and ceramic brackets, fibre reinforced composites have been used as materials for use in orthodontic devices and other areas of medical treatment.

It would therefore be useful to provide a fibre reinforced composite that can be used in the manufacture of orthodontic devices, which overcomes or ameliorates one or more of the disadvantages described above.

### SUMMARY OF THE INVENTION

A first aspect of the present invention provides an orthodontic device comprising a fibre reinforced composite, the composite comprising a fibre material within a matrix phase material, the fibre material comprising a braided fibre material having a braid angle in the range from about 3° to about 87°.

A second aspect of the invention provides a method of forming a fibre reinforced composite for use in orthodontic devices comprising the steps of:

impregnating a fibre material with a monomer resin to form an impregnated fibre, the fibre material comprising braided fibre material having a braid angle in the range from about 3° to about 87°;

shaping the impregnated fibre into a defined cross sectional shape suitable for use in the orthodontic device; and

polymerising the monomer resin to form the fibre-reinforced composite.

### DISCLOSURE OF EMBODIMENTS

Exemplary non-limiting embodiments of an orthodontic device and a method of forming the same will now be disclosed.

In one embodiment, the fibre reinforced composite may further comprise unbraided fibre material within the matrix phase material.

The amount of braided fibre material in the fibre reinforced composite, in volume %, may be selected from the group consisting of: 5% to 60%; 10% to 60%; 15% to 60%; 20% to 60%; 25% to 60%; 30% to 60%; 35% to 60%; and about 40%.

The amount of unbraided fibre material in the fibre reinforced composite, in volume %, may be selected from the group consisting of: 1% to 15%; 1% to 30%; 1% to 25%; 1% to 20%; 1% to 15%; 1% to 10%; 1% to 5%; and 1% to 3%.

The amount of matrix phase material in the fibre reinforced composite, in volume %, may be selected from the group consisting of: 30%-95%; 30-80%; 30-70%; 30-65%; 30-50%; 45-65%; 50-65%; 55-65%; and about 40%.

The braid angle of the braided fibre material may be in the range of from about 10° to about 45°.

The fibre reinforced composite may be comprised of fibre material selected from the group consisting of: metallic fibre; ceramic fibre, polymeric fibre, glass fibre, carbon fibre and any combinations thereof.

Non-limiting examples of metallic fibres include boron, aluminium, stainless steel, molybdenum, tungsten and copper. Non-limiting examples of ceramic fibres include silicon nitride, quartz, aluminium oxide, and silicon carbide. Non-limiting examples of polymeric fibres include poly paraphenylene terephthalamide (Kevlar), polyethylene, polypropylene, nylon or any combinations thereof. Non-limiting examples of glass fibres include E-glass, T-glass, C-glass, R-glass, S-glass and or any combinations thereof. A non-limiting example of carbon fibre is graphite.

The matrix phase material of the fibre-reinforced composite may be a polymer which have no injurious effects on human beings. Suitable, but non limiting, examples of such monomers include: polymethylacrylate, polyethylacrylate, polyhydroxyethylacrylate, polyethyleneglycol diacrylate, poly(di-ethylene glycol diacrylate), poly(tri-ethylene glycol diacrylate), tetra(ethylene glycol diacrylate), poly(bisphenol-A diacrylate), poly(glycidyl acrylate), poly(methyl methacrylate), poly(ethyl methacrylate), poly(hydroxyethyl methacrylate), poly(ethylene glycol dimethacrylate), poly(di-ethylene glycol dimethacrylate), poly(tri-ethylene glycol dimethacrylate), poly(tetraethylene glycol dimethacrylate), poly(bisphenol-A dimethacrylate), poly(glycidyl methacrylate), polystyrene, poly(vinyl acetate), and any combinations thereof.

The orthodontic device may be selected from the group consisting of: orthodontic brackets, orthodontic arch wire, orthodontic face bow, dental post, tooth replacement, periodontal splints, orthodontic retainer and space maintainers, dental bridges and dental implant prosthesis.

The step of shaping the impregnated fibre may comprise a step of passing the impregnated fibre through a pre-forming die having a tunnel shaped according to the defined cross sectional shape.

In one embodiment, the step of shaping the impregnated fibre may further comprise a step of passing the impregnated fibre through a forming guide to conform the braided fibre material into a selected profile prior to entry into the pre-forming die.

The step of polymerizing the monomer resin may comprise a step of curing the monomer resin on the impregnated fibre at a temperature range selected from the group consisting of: 15 to 140° C.; 15 to 120° C.; 15 to 100° C.; 15 to 80° C.; 15 to 60° C.; 15 to 40° C.; 20 to 30° C.; and about 24° C.

The time for which the curing is carried out can be selected from the group consisting of: 15 to 30 hours; 17 to 30 hours; 19 to 30 hours; 21 to 30 hours; 23 to 30 hours; 25 to 30 hours; 27 to 30 hours; 29 to 30 hours; 15 seconds to 28 hours and about 24 hours.

In one embodiment, the step of polymerizing the monomer resin may further comprise a step of post curing the monomer resin on the impregnated fibre at a temperature range selected from the group consisting of: 80 to 120° C.; 85 to 120° C.; 90 to 120° C.; 95 to 120° C.; 100 to 120° C.; 105 to 120° C.; 110 to 120° C.; and about 100° C.

The time for which the post curing is carried out can be selected from the group consisting of: 1 to 3 hours; 1.5 to 3 hours; 2 to 3 hours; 2.5 to 3 hours; and about 2 hours.

In one embodiment, the step of polymerising the monomer resin may comprise the step of exposing the monomer resin on the impregnated fibre to ultra-violet radiation.

### BRIEF DESCRIPTION OF THE DRAWINGS

These and other features, aspects and advantages of the present invention will become better understood from the following description of non-limiting examples with reference to the accompanying drawings, where:

FIG. 1 shows a braided fibre material having a braid angle θ in accordance with the embodiments of the present invention;

FIG. 2 shows a process flow diagram of a method of forming a fibre reinforced composite in accordance with an embodiment of the present invention;

FIG. 3a shows a microscopic view, of about 5 times magnification, of a braided fibre material used in Example 1;

FIG. 3b shows an enlarged view of area A in FIG. 3a;

FIG. 4 shows a U-shape profile of a braided fibre material when it is passed through a forming guide in Example 1;

FIG. 5 shows a cross sectional shape of a pre-forming die used in Example 1;

FIG. 6 shows an elongated fibre reinforced composite formed in Example 1;

FIG. 7 shows an individually cut bracket from the fibre reinforced composite of Example 1;

FIG. 8 shows a machined individually cut bracket of Example 1;

FIG. 9 shows a microscopic profile of a cross sectional view of an orthodontic bracket formed in Example 1;

FIG. 10 shows a direction of force loading on a tie-wing section of an orthodontic bracket in Examples 2 to 4;

FIG. 11 shows a graph comparing properties of orthodontic brackets formed from braided fibres having braid angles 28° and 15° respectively;

FIG. 12 shows a graph comparing properties of orthodontic brackets formed a fibre reinforced composite (braid angle 28°) and an unbraided metallic fibre reinforced composite respectively; and

FIG. 13 shows a of load (N) versus displacement (mm) for an orthodontic bracket formed from a polymeric material.

### DETAILED DESCRIPTION

In an embodiment of the present invention, there is provided an orthodontic device comprising a fibre reinforced composite, the composite comprising a braided fibre material 10 within a matrix phase material. The braided fibre material 10 has a braid angle θ in the range from about 30 to about 87°. In a preferred embodiment, the braid angle θ is in the range from about 10° to about 45°.

In one embodiment, the fibre reinforced composite may further comprise unbraided fibre material within the matrix phase material.

FIG. 1 shows a braided fibre material 10 in accordance with embodiments of the present invention. The braided fibre material 10 has a braid angle, θ, which is an angle formed between the vertical axis 12 along the length of the fibre material and the direction of orientation of the fibre strands 14.

The braided fibre material 10 in accordance with the embodiments of the present invention can be a metallic fibre, ceramic fibre, polymeric fibre, glass fibre carbon fibre or any combinations thereof.

Non-limiting examples of metallic fibres include boron, aluminium, stainless steel, molybdenum, tungsten and copper. Non-limiting examples of ceramic fibres include silicon nitride, quartz, aluminium oxide, and silicon carbide. Non-limiting examples of polymeric fibres include poly paraphenylene terephthalamide (Kevlar), polyethylene, polypropylene, nylon or any combinations thereof. Non-limiting examples of glass fibres include E-glass, T-glass, C-glass, R-glass, S-glass and or any combinations thereof. A non-limiting example of carbon fibre is graphite.

The braided fibre material 10 may be formed from any commercially available fibre braiding machine.

Variations in the braid angle, as will be later illustrated by Example 2, result in fibre reinforced composites of varying mechanical properties. Accordingly, mechanical properties of fibre reinforced composites can be tailored according to specific desired loading requirements of a particular application by varying the braid angle.

In accordance with the embodiment of the present invention, specific desired loading requirement for an orthodontic device is achieved with braid angle in the range from about 3° to about 87°. In the preferred embodiment, the braid angle is in the range from about 10° to about 45° to achieve the desired loading requirements for the orthodontic brackets formed therefrom.

The matrix phase material may be a polymer which have no injurious effects on human beings. Suitable, but non limiting, examples of such monomers include: polymethylacrylate, polyethylacrylate, polyhydroxyethylacrylate, polyethyleneglycol diacrylate, poly(di-ethylene glycol diacrylate), poly(tri-ethylene glycol diacrylate), tetra(ethylene glycol diacrylate), poly(bisphenol-A diacrylate), poly(glycidyl acrylate), poly(methyl methacrylate), poly(ethyl methacrylate), poly(hydroxyethyl methacrylate), poly(ethylene glycol dimethacrylate), poly(di-ethylene glycol dimethacrylate), poly(tri-ethylene glycol dimethacrylate), poly(tetraethylene glycol dimethacrylate), poly(bisphenol-A dimethacrylate), poly(glycidyl methacrylate), polystyrene, poly(vinyl acetate), and any combinations thereof.

The amount of braided fibre material in the fibre reinforced composite may be in the range of 5% to 60% by volume of the composite.

The amount of unbraided fibre material in the fibre reinforced composite may be in the range of 1 to 30% by volume of the composite The amount of matrix phase material in the fibre reinforced composite may be in the range of 30% to 95% by volume of the composite.

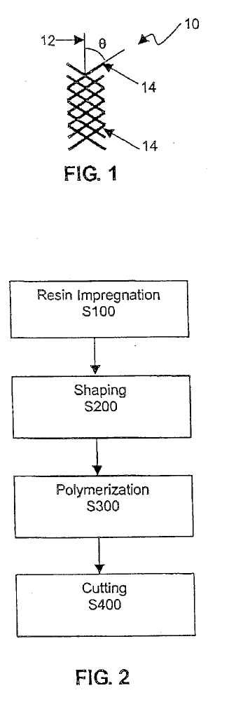

FIG. 2 shows a process flow diagram of a method of forming a fibre reinforced composite, having a defined cross sectional shape, in accordance with the embodiment of the present invention. The method comprises the steps of resin impregnation S100, shaping S200 and polymerisation S300. The method may further comprise a step of cutting S400 the fibre reinforced composite into a desired size.

The step of impregnating S100 a braided fibre material 10 with a monomer resin to form an impregnated fibre, is achieved by passing the braided fibre material 10 into a resin bath containing the monomer resin.

The monomer resin may be admixed with a hardener to improve resin consistency when impregnated onto the fibre. This is to improve processibility of the impregnated fibre when it is transferred from the resin bath to the pre-forming die.

Non-braided fibre material may optionally be introduced simultaneously with the braided fibre into the resin bath if a higher volume fraction of fibre is required in the fibre reinforced composite. The non-braided fibre material may be a fibre strand or a bundle of fibre strands. Increasing the volume fraction of fibres in the composite will increase the mechanical strength and stiffness of the composite.

The monomer resin may be any polymerisable monomer which have no injurious effects on human beings. Suitable, but non limiting, examples of such monomers include: methyl acrylate, ethyl acrylate, hydroxyethyl acrylate, ethylene glycol diacrylate, di-ethylene glycol diacrylate, tri-ethylene glycol diacrylate, tetraethylene glycol diacrylate, bisphenol-A diacrylate, glycidyl acrylate, methyl methacrylate, ethyl methacrylate, hydroxyethyl methacrylate, ethylene glycol dimethacrylate, di-ethylene glycol dimethacrylate, tri-ethylene glycol dimethacrylate, tetraethylene glycol dimethacrylate, bisphenol-A dimethacrylate, glycidyl methacrylate, styrene, vinyl acetate, and any combinations thereof.

The step of shaping S200 the impregnated fibre into a defined cross sectional shape suitable for use in an orthodontic device preferably comprises a step of passing the impregnated fibre through a pre-forming die having a tunnel shaped according to the defined cross sectional shape.

The defined cross sectional shape may be the shape of orthodontic brackets, orthodontic arch wire, orthodontic face bow, dental post, tooth replacement, periodontal splints, orthodontic retainer and space maintainers, dental bridges and dental implant prosthesis.

Optionally, the step of shaping S200 may further comprise a step of passing the impregnated fibre through a forming guide to conform the braided fibre into a selected profile prior to entry into the pre-forming die.

An advantage of conforming the braided fibre into the selected profile is to enable increased fibre distribution in selected areas of the composite where higher structural strength is required. For example, in the narrow sections of the tie wings and arch wire slot of an orthodontic bracket.

The step of polymerising S300 the monomer resin to form the fibre-reinforced composite S300 may comprise a step of curing the monomer resin on the impregnated fibre at a temperature range of 15° C. to 140° C.

The time for which the curing is carried out can be in the range of 15 seconds to 30 hours

In a preferred embodiment, the step of polymerising the monomer resin on the impregnated fibre may further comprise a step of post curing the monomer resin at a temperature range of 80° C. to 120° C.

The time for which the post curing may be carried out can be 1 to 3 hours.

The step of curing the monomer resin on the impregnated fibre may be carried out in the pre-forming die. The pre-forming die may be coated with a mould release agent to facilitate removal of the partially cured impregnated fibre from the die. Post curing of the monomer resin can, for example, be carried out in a post cure oven, or by elevating the temperature of the pre-forming die after the curing at room temperature.

In another embodiment, the step of polymerising S300 the monomer resin may comprise a step of exposing the monomer resin on the impregnated fibre to ultra-violet radiation.

The step of cutting S400 the fibre-reinforced composite into desired sizes for the orthodontic device may be achieved by means of a cutting device such as a diamond wheel. The fibre-reinforced composite that is cut into desired sizes, may be further processed. For instance, in the manufacture of orthodontic brackets, a fibre-reinforced composite having a uniform cross-sectional shape of an orthodontic bracket, is cut into individual brackets of uniform thickness. The base surface of the bracket is then grounded to produce a concave surface to fit the contour of a tooth. Undercuts may be etched onto the concave surface to enhance mechanical adhesion of the orthodontic bracket to orthodontic cements. A moisture impermeable coating may also be applied onto the orthodontic bracket to prevent diffusion of moisture from the external environment into the composite.

In yet another embodiment, colour pigments may be added to produce orthodontic devices of desired colours to improve its aesthetic appearance.

### EXAMPLES

### Example 1

### Forming Fibre-Reinforced Orthodontic Brackets from Braided Fibre Having Braid Angle 28°

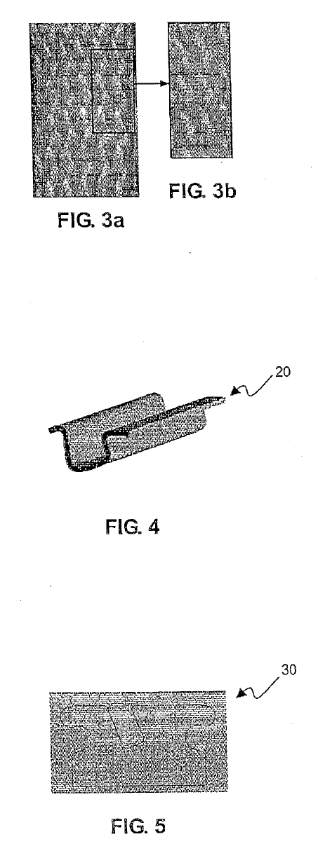

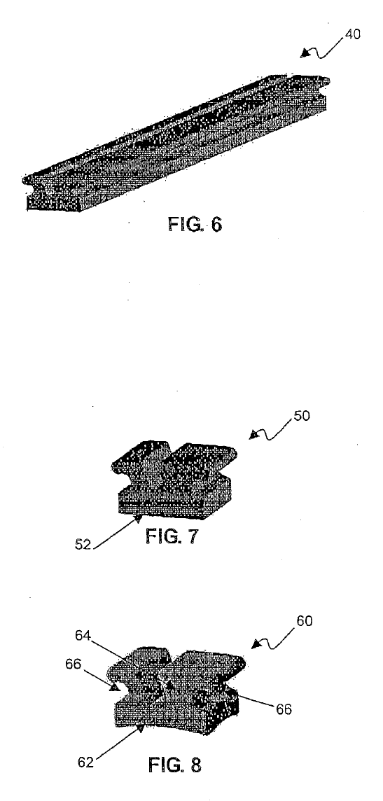

E-Glass fibre of width 7.5 mm, braided at a braid angle of 28° using Kokubun's Braiding Machine (Model ST 20) was passed through a resin bath containing 100 parts by weight of epoxy monomer resin (CHEMI R-50, Chemical Enterprises Pte Ltd, Singapore) and 48 parts by weight of hardener (CHEMI H-64, Chemical Enterprises Pte Ltd, Singapore) to impregnate the braided fibre material with the epoxy monomer resin. FIG. 3a shows a microscopic view of about 5 times magnification, of the braided fibre material. FIG. 3b shows an enlarged view of area A in FIG. 3a. The impregnated fibre was placed in a vacuum chamber for 10 minutes and then passed through a forming guide to conform the impregnated fibre into a U-shaped profile 20 as shown in FIG. 4, and thereafter through a pre-forming die to pre-form the impregnated fibre into a cross sectional shape 30 as shown in FIG. 5. The impregnated fibre was left to cure at room temperature for 24 hours in the pre-forming die, and then transferred into a post cure oven where it was cured at 100° C. for a further 2 hours to form an elongated fibre reinforced composite 40 as shown in FIG. 6. The pre-forming die was coated with a mould release agent to facilitate removal of the partially cured impregnated fibre therefrom. The elongated fibre reinforced composite 40 was then cut into brackets 50 of thickness 3.3 mm as shown in FIG. 7. Each of the individually cut brackets 50 are then machined into orthodontic brackets 60 as shown in FIG. 8, by first grinding its base surface 52 to produce a concave surface 62 to match the contour of a tooth. The concave surface 62 has undercuts to enhance mechanical adhesion to orthodontic cements. Portions 64 and 66 are coated with a thin uniform layer of moisture impermeable coating.

The resultant orthodontic bracket was visually observed to be translucent.

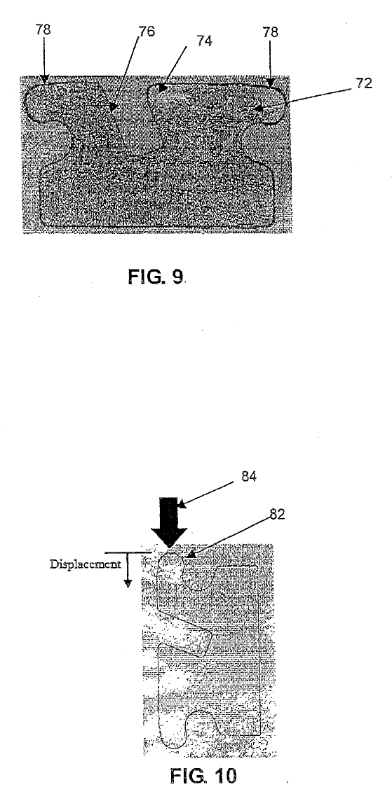

FIG. 9 shows a microscopic profile of a cross-sectional view of the orthodontic bracket. The black portions 72 indicate the fibre phase, and the white portions 72 indicate the matrix phase. It was observed that the E-glass fibres were distributed substantially throughout the entire cross sectional area, particularly the narrow sections of the tie wings 78 and archwire slot 76. The measured volume fraction of fibre was 49%.

### Example 2

### Comparison of Properties of Orthodontic Brackets Formed from Braided Fibres with Braiding Angles 28° and 15° Respectively

A fibre reinforced composite orthodontic bracket formed from E-Glass fibre having a braid angle of 15° was formed in accordance with the method of Example 1.

Another fibre reinforced composite orthodontic bracket formed from E-Glass fibre having a braid angle of 28° was formed in accordance with the method of Example 1.

Force loadings of 20N, 40N, 60N and 80N were applied on the tie wing section 82 of each of the orthodontic brackets formed from E-glass fibres having braid angles 28° and 15° in a direction 84 as shown in FIG. 10. Displacement of the tie wing section 82 downwards was measured for each force loading value. Readings from the experiment were shown in a graph of load (N) versus displacement (mm) for each of the two brackets in FIG. 11.

Curve 92 shows results for the bracket formed from E-Glass fibre having braid angle 28°. A linear slope of 1028 N/mm was observed.

Curve 90 shows results for the bracket formed from E-Glass fibre having braid angle 15°. A linear slope of 866 N/mm was observed.

From the above results, it can be clearly seen that the bracket formed from the E-Glass fibre having a braid angle of 28° can withstand a higher load than the bracket formed from the E-glass fibre having braid angle of 15°.

Therefore, variations in the braid angle of the braided fibre material can result in fibre reinforced composites of different mechanical properties. Accordingly, composites of desired mechanical properties can be achieved by adjusting the braid angle of the braided fibre material.

### Example 3

### Comparison of Properties of Orthodontic Brackets Formed from Fibre Reinforced Composite (Braiding Angle 28°) and Unbraided Metallic Fibre Reinforced Composite

An orthodontic bracket formed from a fibre reinforced composite (braiding angle 28°) was prepared in accordance with the method of Example 1.

A similar sized commercially available orthodontic bracket (Elation, GAC) formed from an unbraided metal fibre reinforced polymer composite was obtained.

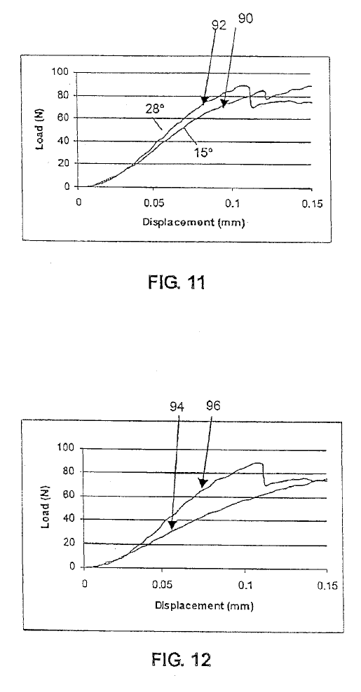

Force loadings of 20N, 40N, 60N and 80N were applied on the tie wing section 82 of each of the orthodontic brackets in a direction 84 as shown in FIG. 10. Displacement of the tie wing section 82 downwards was measured for each loading. Readings from the experiment were shown in a graph of load (N) versus displacement (mm) for each of the two brackets in FIG. 12.

Curve 96 shows results for the bracket formed from the fibre reinforced composite (braiding angle 28°). A linear slope of 1028 N/mm was observed.

Curve 94 shows results for the bracket formed from the metal reinforced composite. A linear slope of 620 N/mm was observed.

From the above results, it can be concluded that the bracket formed from the fibre reinforced composite of the present invention can withstand a higher load than the similarly sized bracket formed from the metal reinforced polymer composite.

Accordingly, the fibre reinforced polymer composite of the present invention possesses higher mechanical strength than metal reinforced polymer composites. In particular, fibre reinforced composites formed from braided fibre material having a braid angle of 28°, possesses higher mechanical strength than polymer composites reinforced with unbraided metal fibres.

### Example 4

### Comparison of Properties of Orthodontic Brackets Formed from Formed from Fibre Reinforced Composite (Braiding Angle 28°) and Polymeric Material (without Fibre Reinforcement)

An orthodontic bracket formed from a fibre reinforced composite (braiding angle 28°) was prepared in accordance with the method of Example 1.

A similar sized neat polymeric orthodontic bracket was formed from the following method. Polymeric resin comprising 100 parts by weight of epoxy monomer resin (CHEMI R-50, Chemical Enterprises Pte Ltd, Singapore) and 48 parts by weight of hardener (CHEMI H-64, Chemical Enterprises Pte Ltd, Singapore) was injected into a pre-forming die to conform the resin into a cross sectional shape 30 as shown in FIG. 5. The resin was cured at room temperature for 24 hours in the pre-forming die and then transferred into a post cure oven where it was cured at 100° C. for a further 2 hours to form an elongated solid polymeric material of a shape similar to the one 40 as shown in FIG. 6. The elongated solid polymeric material was then cut into individual brackets of thickness 3.3 mm to form the polymeric orthodontic bracket.

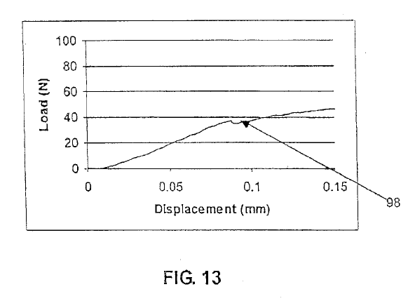

Force loadings of 20N, 40N, 60N and 80N were applied on the tie wing section 82 of each of the orthodontic brackets in a direction 84 as shown in FIG. 10. Displacement of the tie wing section 82 downwards was measured for each loading. Readings from the experiment were shown in a graph of load (N) versus displacement (mm) for the polymeric orthodontic bracket in FIG. 13. This was compared with the experimental results for the bracket formed from braided fibres with braid angle 28° from Example 2.

Curve 92 of FIG. 11 shows results for the bracket formed from the fibre reinforced composite (braiding angle 28°). A linear slope of 1028 N/mm was observed.

Curve 98 shows results for the bracket formed from the polymer with no fibre reinforcement. A linear slope of 538 N/mm was observed.

From the above results, it can be concluded that the bracket formed from the fibre reinforced composite of the present invention can withstand a higher load than the similarly sized bracket formed from the a polymer with no fibre reinforcement. Accordingly, the fibre reinforced polymer composite of the present invention possesses higher mechanical strength than polymers with no reinforcement fibres.

The fibre reinforced composite of the present invention can be employed as a material for use in medical treatment, for example in medical products such as periodontal drug pultruded rope and nerve guide conduits. Particularly, the fibre reinforced composite of the present invention may be well-suited for use in orthodontic treatment, for example, in orthodontic arch wire, orthodontic face bow, dental post, tooth replacement, periodontal splints, orthodontic retainer and space maintainers, dental bridges and dental implant prosthesis. More particularly, the fibre reinforced composite in accordance with the embodiments of the present invention can be used to form orthodontic brackets for use in orthodontic treatment.

An advantage of the present invention is that mechanical properties of fibre reinforced composites can be tailored according to specific desired loading requirements of a particular application by varying the braid angle of the braided fibre.

Another advantage of the fibre reinforced composite of the present invention is that the orthodontic bracket formed therefrom is translucent, and therefore aesthetic in appearance.

Yet another advantage of the fibre reinforced composite of the present invention is that the orthodontic bracket formed therefrom has desirable mechanical properties, and accordingly, is not susceptible to deformation and fracture.

It will be appreciated that the invention is not limited to the embodiments described herein, and additional embodiments or various modifications may be derived from the application of the invention by a person skilled in the art without departing from the scope of the invention.

What is claimed is:

1. A method of forming a fibre reinforced composite for use in orthodontic devices comprising the steps of:
impregnating a fibre material with a monomer resin to form an impregnated fibre, the fibre material comprising a braided fibre material having a braid angle in the range of from about 3° to about 87°;
shaping the impregnated fibre into a defined cross sectional shape suitable for use in the orthodontic device; and
polymerizing the monomer resin to form the fibre-reinforced composite.

2. The method according to claim 1, wherein the step of shaping the impregnated fibre comprises the step of passing the impregnated fibre through a pre-forming die having a tunnel shaped according to the defined cross sectional shape.

3. The method according to claim 2, wherein the step of shaping the impregnated fibre further comprises the step of passing the impregnated fibre through a forming guide to conform the braided fibre material into a selected profile prior to entry into the pre-forming die.

4. The method according to claim 1, wherein the step of polymerising the monomer resin comprises the step of curing the monomer resin on the impregnated fibre at a temperature range selected from the group consisting of: 15 to 140° C.; 15 to 120° C.; 15 to 100° C.; 15 to 80° C.; 15 to 60° C.; 15 to 40° C.; 20 to 30° C.; and about 24° C.

5. The method according to claim 1, wherein the step of polymerising the monomer resin comprises the step of curing the monomer resin for a period of time selected from the group consisting of: 15 seconds to 30 hours; 17 to 30 hours; 19 to 30 hours; 21 to 30 hours; 23 to 30 hours; 25 to 30 hours; 27 to 30 hours; 29 to 30 hours and about 24 hours.

6. The method according to any one of claims 1, wherein the step of polymerising the monomer resin further comprises the step of post curing the monomer resin on the impregnated fibre at a temperature range selected from the group consisting of: 80 to 120° C.; 85 to 120° C.; 90 to 120° C.; 95 to 120° C.; 100 to 120° C.; 105 to 120° C.; 110 to 120° C.; and about 100° C.

7. The method according to any one of claims 1, wherein the step of polymerising the monomer resin further comprises the step of post curing the monomer resin on the impregnated fibre for a period of time selected from the group consisting of: 1 to 3 hours; 1.5 to 3 hours; 2 to 3 hours; 2.5 to 3 hours; and about 2 hours.

8. The method according to claim any one of claims 1, wherein the step of polymerising the monomer resin comprises the step of exposing the monomer resin on the impregnated fibre to ultra-violet radiation.
